(19) United States
(12) Patent Application Publication
(10) Pub. No.: US 2013/0032224 A1
(43) Pub. Date: Feb. 7, 2013

(54) BASEMENT FLOOR DRAIN AND METHOD

(71) Applicants: Stephen Andras, Westport, MA (US); John E. Walsh, Norfolk, MA (US)

(72) Inventors: Stephen Andras, Westport, MA (US); John E. Walsh, Norfolk, MA (US)

(21) Appl. No.: 13/426,059

(22) Filed: Mar. 21, 2012

Related U.S. Application Data
(62) Division of application No. 11/592,483, filed on Nov. 3, 2006, now abandoned.

(51) Int. Cl. E03C 1/12; B23P 17/04

(52) U.S. Cl. 137/362; 29/428

(57) ABSTRACT

A basement floor drain for use in basement waterproofing systems. The floor drain contains an upper chamber for collecting water, and an air resistant lower chamber to promote the establishment of a closed waterproofing system. A valve regulates flow of water from the upper chamber to the lower chamber. An outlet in the lower chamber may be fluidly connected to a basement sump to facilitate extraction of collected water. A basket may be included in a base of the upper chamber to protect the valve from clogging, and the basket may be removable to aid cleaning. The floor drain may be a modular assembly, multiple components of which may be coupled for customizable size and functionality.

### BACKGROUND OF THE INVENTION

1. Field of the Invention

At least one embodiment of the present invention relates generally to devices and methods for basement waterproofing and, more particularly, to floor drains for use in basement waterproofing systems.

2. Discussion of Related Art

The potential for moisture in the basement of buildings is of ongoing concern to homeowners, building contractors, and structural engineers. Wetness in a basement can cause significant structural damage, as well as promote the growth of harmful bacteria, such as iron bacteria. The groundwater level may periodically rise due to rain or melting snow, causing leakage at cracks in foundation footings, structural interfaces, and up through the basement floor. Sub-floor drainage conduits are conventionally installed along the basement perimeter to convey groundwater to a sump for extraction.

Water may also originate from above the basement floor. Floor drains have been installed to collect such water, for example, near basement plumbing fixtures and bulkhead stairs. Traditional basement floor drains are molded or extruded in about six foot pieces, and are typically cut to a desired length during installation.

### BRIEF SUMMARY OF THE INVENTION

In accordance with one or more embodiments, the invention relates generally to an improved basement floor drain for use in basement waterproofing systems.

In accordance with one or more embodiments, the invention relates to a basement floor drain, comprising an upper chamber constructed and arranged to collect water, an air resistant lower chamber in fluid communication with the upper chamber, and a valve configured to regulate flow of water from the upper chamber to the air resistant lower chamber.

The valve may comprise a cantilever. The drain may further comprise a separator in a base of the upper chamber, constructed and arranged to minimize clogging of the valve. The separator may comprise a basket which may be removably received by the base of the upper chamber. The basket may extend into the air resistant lower chamber and may comprise a detachable lid having a plurality of apertures. The valve may comprise a cantilever in mechanical cooperation with an outlet of the basket to regulate flow of water from the upper chamber to the air resistant lower chamber. The drain may further comprise a removable drain cover coupled to the upper chamber and having a plurality of apertures. The air resistant lower chamber may include an outlet to facilitate fluidly connecting the drain to a basement waterproofing system. The drain may comprise a plurality of detachable segments including a first detachable segment and a second detachable segment. The air resistant lower chamber may be coupled to the first detachable segment, and the drain may further comprise a second air resistant lower chamber fluidly connected to the second detachable segment. The drain may comprise an end cap at a distal end of the upper chamber. A length of the drain may be longer than a width of the drain.

In accordance with one or more embodiments, the invention relates to a method of assembling a basement floor drain, comprising acts of providing a first floor drain element having an upper chamber constructed and arranged to collect water, and having an air resistant lower chamber in fluid communication with the upper chamber, coupling the first floor drain element to a second floor drain element, and installing the floor drain in a basement floor.

Coupling the first floor drain element to the second floor drain element may comprise creating an extended upper chamber. The method may comprise a step of fluidly connecting the extended upper chamber to an air resistant lower chamber of the second floor drain element. The method may also comprise a step of inserting a removable basket into a base of the upper chamber. The method may further comprise a step of applying an end cap to a distal end of the extended upper chamber. The method may still further comprise a step of applying a removable drain cover having a plurality of apertures to the upper chamber.

In accordance with one or more embodiments, the invention relates to a method of waterproofing a basement, comprising acts of installing a floor drain into a floor of the basement, the floor drain having an upper chamber constructed and arranged to collect water, and having an air resistant lower chamber in fluid communication with the upper chamber, and regulating flow of water from the upper chamber to the air resistant lower chamber.

The method may further comprise a step of fluidly connecting the air resistant lower chamber to a basement sump to facilitate extraction of collected water from the basement. Installing the floor drain may comprise adjusting a length of the upper chamber. Installing the floor drain may also comprise fluidly connecting a second air resistant lower chamber to the upper chamber. Regulating flow of water from the upper chamber to the air resistant lower chamber may comprise utilizing a one-way flow valve. Utilizing a one-way flow valve may comprise utilizing a valve containing a cantilever.

In accordance with one or more embodiments, the invention relates to a basement floor drain kit. The kit may comprise a floor drain element having an upper chamber constructed and arranged to collect water, and having an air resistant lower chamber in fluid communication with the upper chamber. The kit may also comprise a first upper chamber extender element constructed and arranged to increase an effective length of the upper chamber to create an extended upper chamber.

The kit may include a valve for regulating flow of water from the extended upper chamber to the air resistant lower chamber. The valve may comprise a cantilever. The first upper chamber extender element may be substantially identical to the floor drain element. The kit may comprise an upper chamber end cap, and a removable drain cover defining a plurality of apertures. The kit may further comprise a basket configured to be removably received in a base of the upper chamber. The kit may still further comprise a second upper chamber extender element. A length of the first upper chamber extender element may be greater than a length of the second upper chamber extender element.

Other advantages, novel features and objects of the invention will become apparent from the following detailed description of the invention when considered in conjunction with the accompanying drawings.

### BRIEF DESCRIPTION OF THE DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments of the present invention will be described with reference to the accompanying drawings, in which:

FIG. 1 illustrates a basement floor drain installed as a component of a basement waterproofing system in accordance with one or more embodiments of the present invention;

FIG. 2 illustrates a perspective view of a basement floor drain in accordance with one or more embodiments of the present invention;

FIG. 2A illustrates a detailed view of a drain cover in accordance with one or more embodiments of the present invention;

FIG. 3 illustrates a perspective view of a cantilever valve in accordance with one or more embodiments of the present invention;

FIG. 4 illustrates a removable basket of a basement floor drain in accordance with one or more embodiments of the present invention;

FIG. 5 illustrates a detailed view of the basket of FIG. 4 in accordance with one or more embodiments of the present invention;

FIG. 6 illustrates the cantilever valve of FIG. 3 in mechanical cooperation with the basket of FIG. 5 in accordance with one or more embodiments of the present invention;

FIG. 6A illustrates the cantilever valve of FIG. 3 in mechanical cooperation with the basket of FIG. 5 in accordance with one or more embodiments of the present invention;

FIG. 7 illustrates a perspective view of a floor drain element in accordance with one or more embodiments of the present invention;

FIG. 8 illustrates a perspective view of an upper chamber extender element in accordance with one or more embodiments of the present invention;

FIG. 9 illustrates a modular floor drain in accordance with one or more embodiments of the present invention; and

FIG. 10 illustrates a detailed view of an upper chamber end cap in accordance with one or more embodiments of the present invention.

### DETAILED DESCRIPTION OF THE INVENTION

This invention is not limited in its application to the details of construction and the arrangement of components as set forth in the following description or illustrated in the drawings. The invention is capable of embodiments and of being practiced or carried out in various ways beyond those exemplarily presented herein.

In accordance with one or more embodiments, the present invention relates generally to an improved basement floor drain. The floor drain may be effective in collecting water that originates from above the basement floor in order to prevent penetration of the basement structure. The floor drain may be strategically installed in locations generally prone to basement leaks and/or spillage. For example, the floor drain may be positioned near bulkhead stairs, a clothing washer unit, a sink or other basement plumbing fixture. The floor drain may be installed so as to promote the flow of water towards the floor drain. For example, the floor drain may be installed flush with the basement floor, and the basement floor may be pitched towards the floor drain.

The floor drain may be constructed of any material suitable for its intended purpose. The floor drain material should be durable and generally compatible with water, soil, concrete, and any minerals or chemicals with which it may come into contact. In some embodiments, the floor drain may be made of a polyvinyl chloride (PVC) plastic. The floor drain may be of any desired shape for a particular application. In at least one embodiment, for example, the floor drain is generally rectangular in geometry. The dimensions of the disclosed floor drain may also vary for different applications. In general and without limiting the scope of the present disclosure, a typical rectangular floor drain may be about one foot high and between about four to six inches wide in cross-section, and between about one to six feet in length.

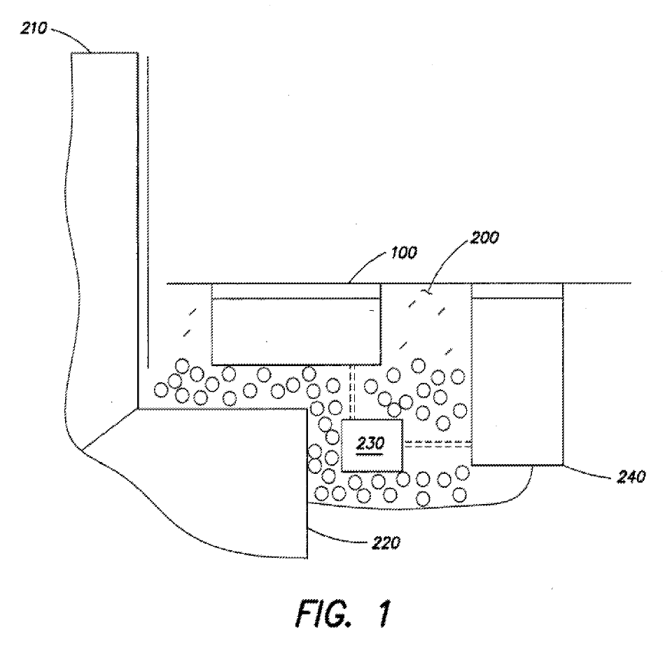

FIG. 1 illustrates a floor drain 100 in accordance with one or more embodiments of the present invention, positioned relative to a basement floor 200, foundation wall 210 and a footing 220. The floor drain 100 is installed generally flush with the basement floor 200. While the floor drain 100 is exemplarily positioned proximate to the foundation wall 210, it should be noted that the floor drain 100 may be positioned elsewhere, such as towards the middle of the basement floor 200. As illustrated, the floor drain 100 may be installed as part of a basement waterproofing system. For example, the floor drain 100 may be fluidly connected to a basement sump 240 via a conduit 230 to facilitate extraction of collected water. In one embodiment, the conduit 230 may be implemented using a conduit as described in copending U.S. patent application Ser. No. 11/471,867 to Andras which is hereby incorporated herein by reference in its entirety. Likewise, the sump 240 may be implemented in accordance with copending U.S. patent application Ser. No. 11/529,060 to Andras which is also hereby incorporated herein by reference in its entirety.

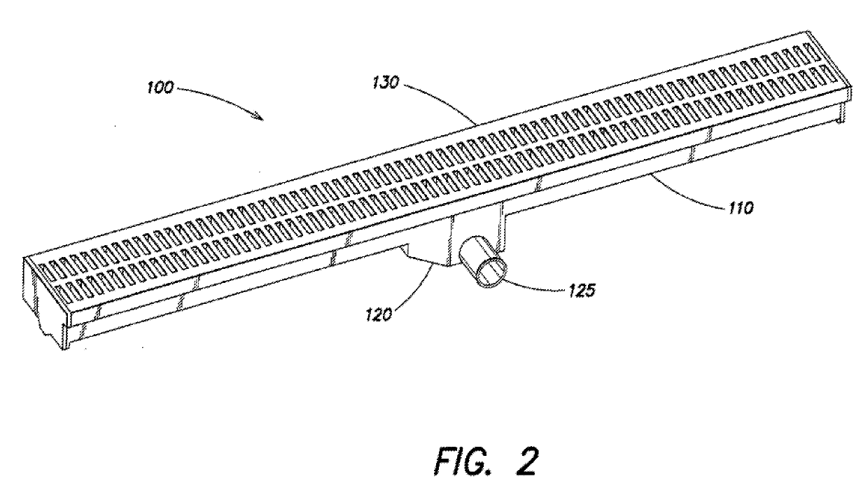

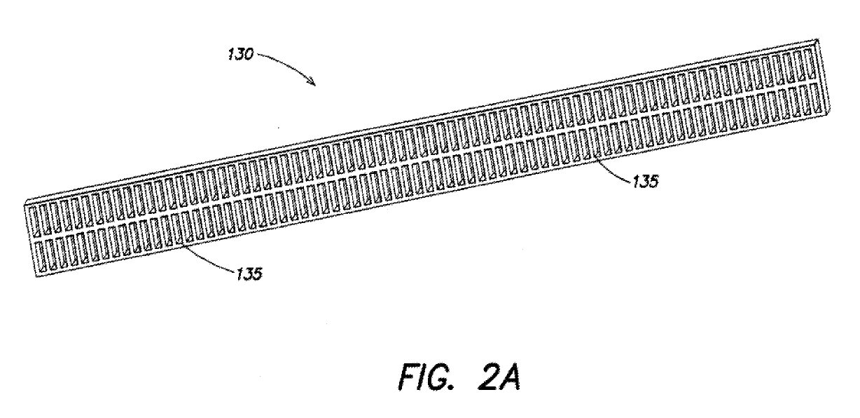

According to one or more embodiments, the floor drain 100 may include an upper chamber 110 and a lower chamber 120, as illustrated in FIG. 2. The upper chamber 110 is generally open to the interior of the basement, and may be constructed and arranged to collect water from the surface of the surrounding basement floor. The floor drain 100 may include a drain cover 130, as detailed in FIG. 2A, having a plurality of apertures 135 through which water may enter the upper chamber 110. The apertures 135 may be of any size, shape and orientation, but should generally be designed and positioned to both promote water entry and prevent clogging. In at least one embodiment, the drain cover 130 may be detachable, such as with a snap-off technique, to allow access to the interior of the floor drain 100 for cleaning and/or maintenance. The lower chamber 120 may be fluidly connected to the upper chamber 110. In some embodiments, the lower chamber 120 may be generally smaller than the upper chamber 110 in dimension.

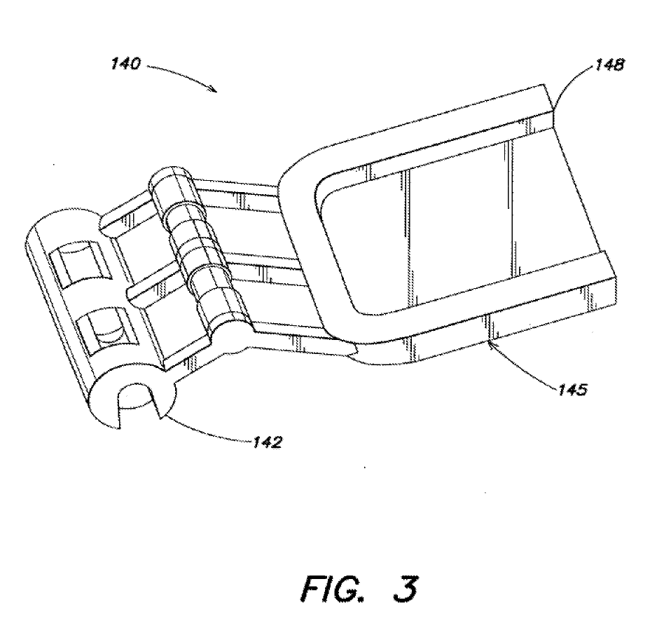

According to one or more embodiments, the floor drain 100 may include a valve to regulate flow of water from the upper chamber 110 to the lower chamber 120. Various types of valves commonly known to those skilled in the art may be implemented. In some embodiments, the valve may be a one-way valve, such as a spring loaded ball valve. In other embodiments, the valve may include a single movable component. For example, in at least one embodiment, the valve may comprise a cantilever 140, as illustrated in FIG. 3, to regulate flow of water from the upper chamber 110 to the lower chamber 120.

The cantilever 140 may generally include a weighted portion 142 and a regulator 145. In some embodiments, the cantilever 140 may be configured to rotate about a pivot point. The weighted portion 142 may balance the regulator 145 in a resting position such that the regulator 145 blocks fluid passage from the upper chamber 110 to the lower chamber 120. Water collected in the upper chamber 110 may exert a force on the regulator 145 to overcome the balance of the cantilever 140. Thus, the regulator 145 may be moved away from its resting position, allowing fluid passage from the upper chamber 110 to the lower chamber 120. In some embodiments, the weight of about one to two teaspoons of water in the upper chamber 110 may be sufficient to open the cantilever 140. When the upper chamber 110 no longer contains a volume of water sufficient to disrupt the balance of the cantilever 140, the weighted portion 142 will restore the balance and the regulator 145 will return to its resting position to block fluid flow. Depending on the rate of water collection in the upper chamber 110, the cantilever 140 may be opened periodically or continuously. The regulator 145 may contain a lip 148 to direct water towards the lower chamber 120.

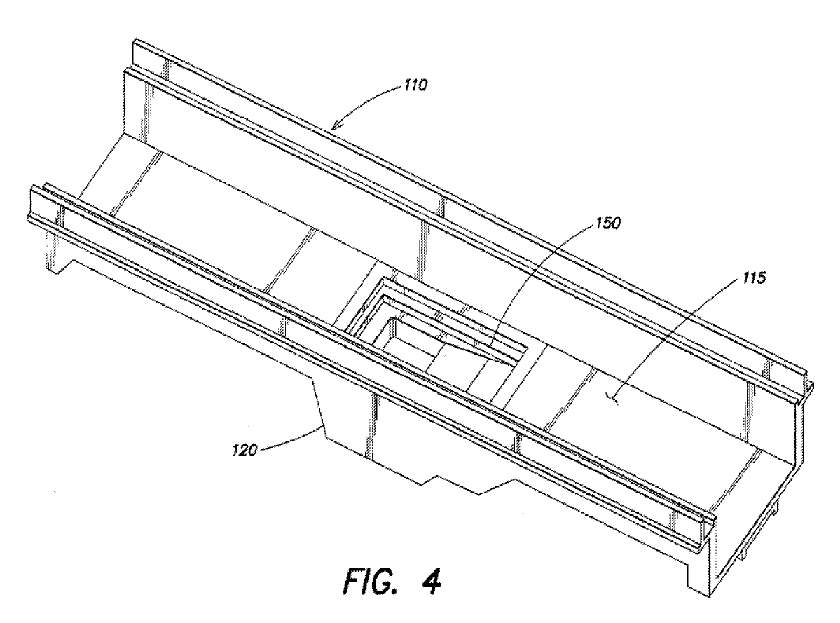

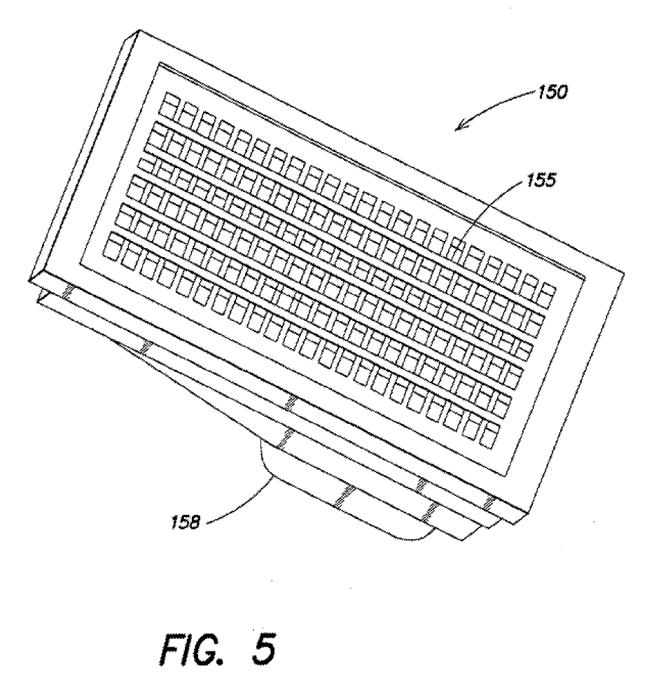

According to one or more embodiments, the floor drain 100 may also include a separator in a base 115 of the upper chamber 110, constructed and arranged to minimize clogging of the valve. For example, the separator may include a screen, filter or grate. In at least one embodiment, the separator may comprise a basket 150 in a base 115 of the upper chamber 110, as illustrated in FIG. 4 and detailed in FIG. 5. The basket 150 may extend into the lower chamber 120, and may generally be constructed and arranged to minimize and/or prevent clogging of the valve. For example, the basket 150 may be aligned with the valve to capture dirt and debris as water passes from the upper chamber 110 to the valve. In some embodiments, the base 115 may slope towards the basket 150 to promote drainage of water from the upper chamber 110 through the basket 150. The basket 150 may be removable for cleaning or maintenance. The basket 150 may contain a lid 155 having a plurality of apertures, such as a mesh or screen. The apertures should generally be designed and positioned to both promote passage of water and block debris. The lid 155 may be removable to allow access to the interior of the basket 150, such as for cleaning.

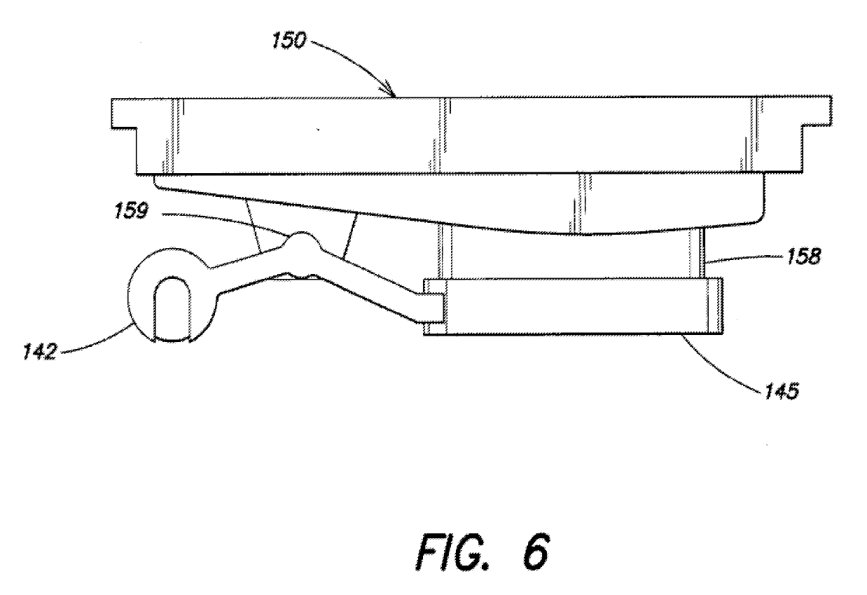

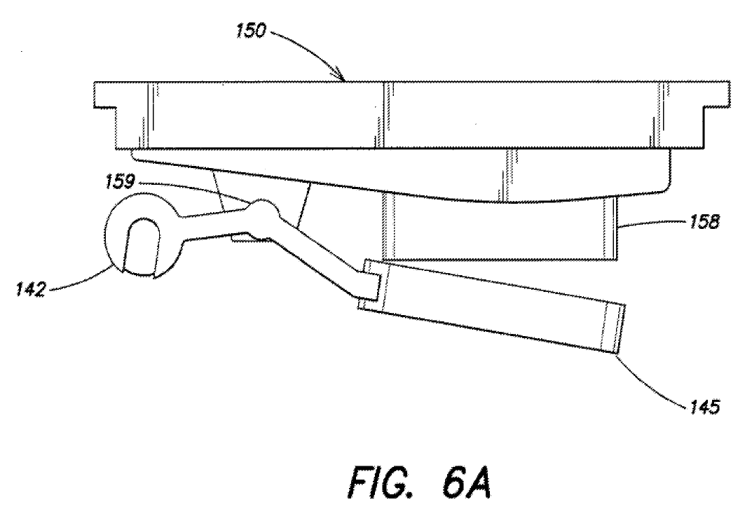

In some embodiments, an outlet 158 of the basket 150 may cooperate with the valve to regulate flow of water from the upper chamber 110 to the lower chamber 120. For example, in embodiments where the valve comprises a cantilever 140, the cantilever 140 may function in mechanical cooperation with the outlet 158. In the resting position for the cantilever 140, as illustrated in FIG. 6, the regulator 145 may block the outlet 158, preventing fluid flow. A force exerted by collected water in the upper chamber 110 may disrupt the balance of the cantilever 140. The regulator 145 may be moved away from the outlet 158 to an open position, as illustrated in FIG. 6A, allowing fluid flow to the lower chamber 120. The weighted portion 142 may eventually restore the balance of the cantilever 140, returning the regulator 145 to its closed resting position against the outlet 158. Beneficially, if the cantilever 140 was to become damaged for some reason, it would fall into the lower chamber 120 leaving the outlet 158 open so as to prevent basement flooding.

In at least one embodiment, the valve, such as the cantilever 140, may be integrated into the structure of the basket 150. For example, as illustrated in FIG. 6, the cantilever 140 may be connected to the basket 150. A hinge or other mechanical attachment 159 may join the cantilever 140 to the basket 150 and may serve as a pivot point for the cantilever 140. Beneficially, the valve may be accessed by simply removing the basket 150 from the floor drain 100.

As discussed above, the floor drain 100 may be installed as part of a basement waterproofing system. An outlet 125 in the lower chamber 120 (FIG. 1) may be fluidly connected to a basement sump via a sub-floor drainage conduit. In operation, water collected in the upper chamber 110 may flow to the lower chamber 120 and may then be conveyed to the basement sump via the sub-floor drainage conduit for extraction from the basement structure.

In at least one embodiment, the lower chamber 120 may be generally air resistant to promote the establishment of a closed basement waterproofing system. Without wishing to be bound by any particular theory, a closed system may serve to eliminate any airflow path between sub-floor and above-floor levels. Such a closed system may aid in containing radon gas and bacteria at the sub-floor level. Additionally, the closed system may promote energy conservation, such as by alleviating the need to dehumidify the basement environment. The nature of the valve regulating flow between the upper chamber 110 and the lower chamber 120 may influence the extent to which the lower chamber 120 is air resistant. For example, in some embodiments the lower chamber 120 may be about 99% air resistant. In embodiments wherein the valve comprises a cantilever 140, the closed resting position of the regulator 145, as well as the upper chamber 110 water level in the open position, may serve to maintain air-resistance in the lower chamber 120. The air resistant lower chamber 120 may be connected to other components of a closed basement waterproofing system, as discussed above, including a drainage conduit and sump.

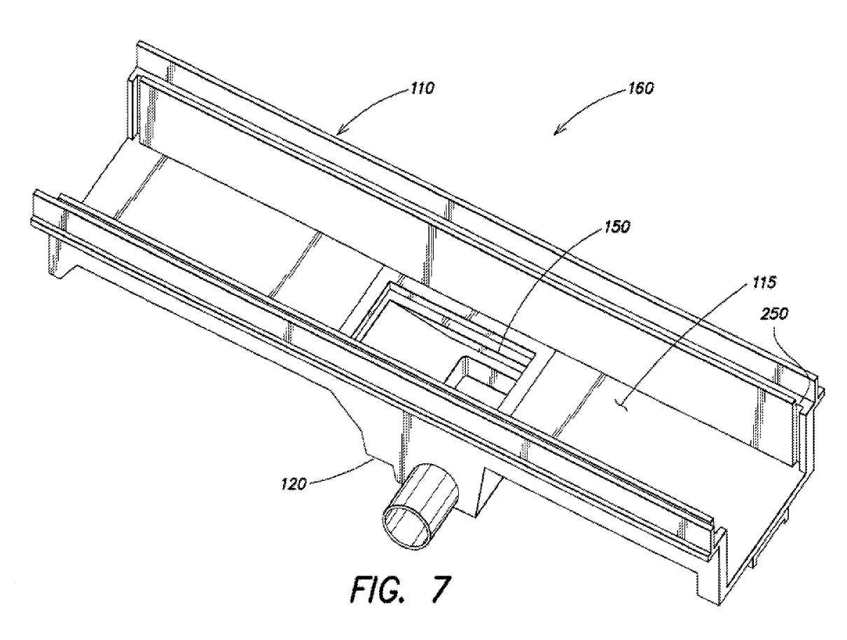

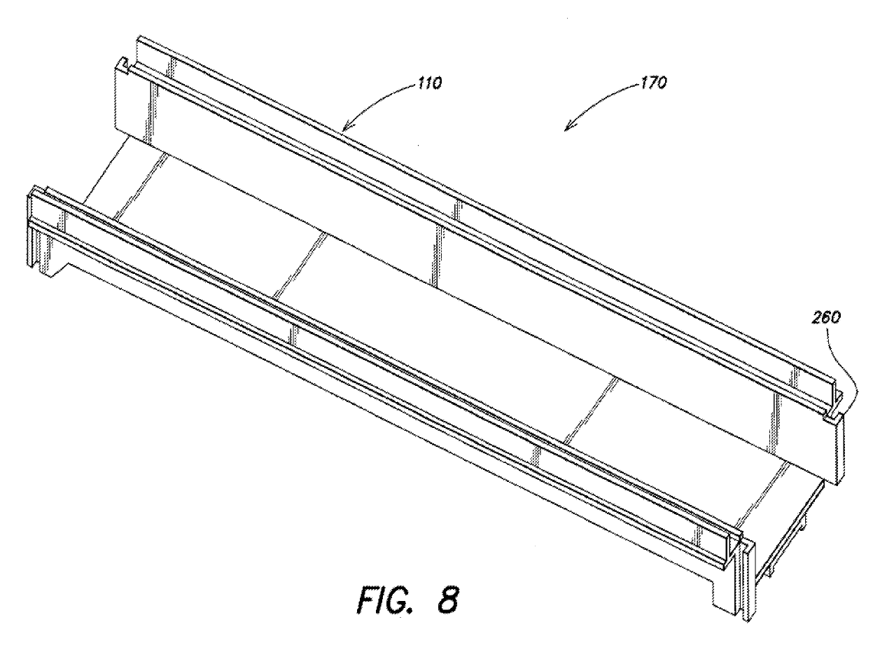

In some embodiments, the disclosed floor drain 100 may be a modular assembly, multiple components of which may be interchangeably and detachably coupled together for customized installation. A floor drain element 160, as illustrated in FIG. 7, may have an upper chamber 110 constructed and arranged to collect water, and have an air resistant lower chamber 120 in fluid communication with the upper chamber 110. The floor drain element 160 may, for example, be about one foot in length. A valve may be included in the floor drain element 160 to regulate flow of water from the upper chamber 110 to the lower chamber 120. A basket 150 may also be included in the floor drain element 160 to protect the valve from clogging. In some embodiments, the floor drain element 160 may be coupled to one or more upper chamber extender elements 170, as illustrated in FIG. 8, to increase an effective length of the upper chamber so as to create an extended upper chamber. The upper chamber extender elements 170 may be provided in various lengths for design flexibility. For example, and without limiting the scope of the present disclosure, a first upper chamber extender element 170 may be about one foot in length, and a second upper chamber extender element 170 may be about six inches in length. The upper chamber extender element 170 may alternatively be substantially identical to the floor drain element 160 of FIG. 7, including an air resistant lower chamber.

Structural design features of components of the modular floor drain 100, such as those defining a mating system, may be used to assemble the components. In some embodiments, an assembly system involving male and female mating sections or connectors may facilitate assembly of the floor drain without requiring an adhesive or mechanical attachment. For example, an end of a floor drain element 160 may include a groove 200 configured to removably receive a tongue 210 in an end of an upper chamber extender element 170. Depending on the nature of the mating features, a force may be applied to ensure connection between the detachable floor drain segments.

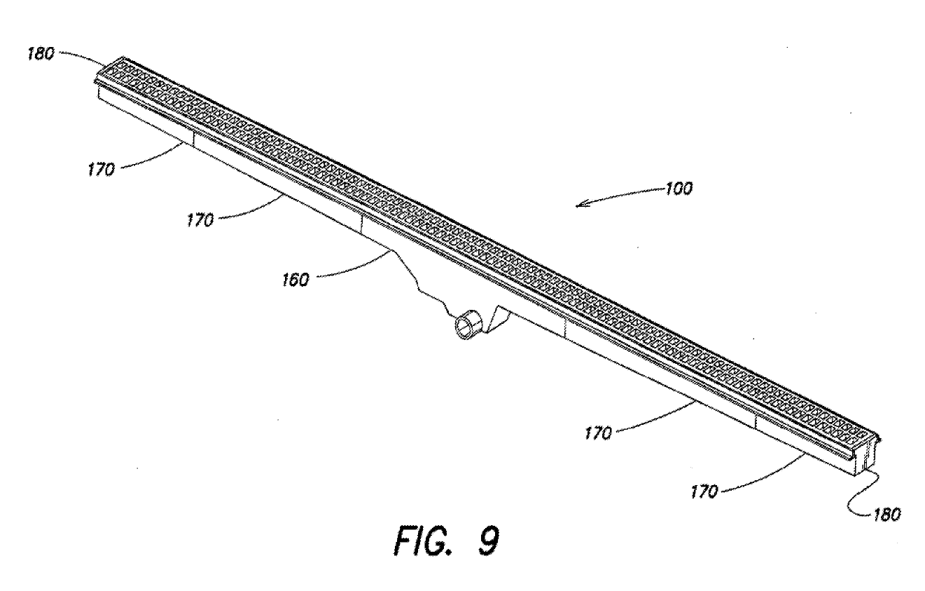

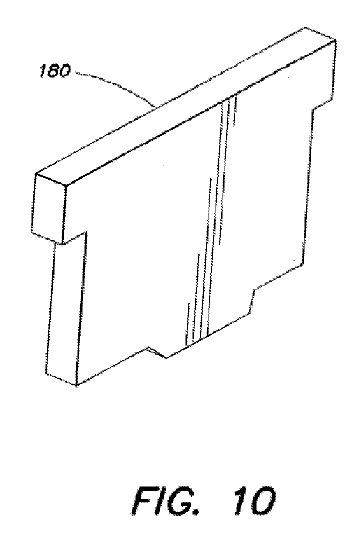

Any combination of floor drain components may be coupled to assemble a floor drain with a desired length and/or functionality. For example, a one foot floor drain element 160 may be coupled between two one foot upper chamber extender elements 170 to create a three foot assembled floor drain. In some embodiments, additional six inch upper chamber extender elements 170 may be applied to each end as illustrated in FIG. 9 to create a four foot assembled floor drain. In other embodiments where it may be desirable to include a second air resistant lower chamber, an additional floor drain element 160 may be coupled into the floor drain design. Upper chamber end caps 180, as detailed in FIG. 10, may be applied to enclose distal ends 185 of an assembled floor drain 100. A single drain cover 130 may be of a sufficient length to accommodate an assembled floor drain or, alternatively, multiple drain covers 130 may be applied in series.

A floor drain kit may be provided for assembly of a drain in accordance with one or more embodiments of the present invention. For example, the floor drain kit may include a floor drain element having an upper chamber constructed and arranged to collect water, and having an air resistant lower chamber in fluid communication with the upper chamber. The kit may further include a valve, such as a cantilever, for regulating flow of water from the upper chamber to the air resistant lower chamber. The kit may also include at least one upper chamber extender element. The upper chamber extender elements may be of a variety of lengths to enable customized installation. Some upper chamber extender elements may serve solely to extend the upper chamber. Other upper chamber extender elements may be substantially identical to the first floor drain element, including an air resistant lower chamber. The kit may include one or more end caps for enclosing distal ends of the upper chamber of an assembled floor drain. A basket configured to be removably received in a base of the upper chamber as discussed above may be included. A removable drain cover defining a plurality of apertures may also be provided in the kit.

Existing basement waterproofing systems may be retrofitted in accordance with one or more embodiments of the present invention. For example, a preexisting basement floor drain may be replaced with a floor drain constructed and arranged substantially as described herein. Fluid connections may be made between the new floor drain and other components of a preexisting basement waterproofing system. Additional components, for example a drainage conduit or basement sump, may also be replaced or installed as part of a retrofit application.

In some embodiments, an antimicrobial agent, commonly known to those skilled in the art, may be incorporated into the floor drain material prior to molding or extraction in order to impart antimicrobial properties to the resulting drain. For example, the antimicrobial compound may be added in an amount of about three to five percent by weight. Without wishing to be bound to any particular theory, a basement floor drain having an antimicrobial active surface may be effective in preventing the development of a harmful biofilm thereon.

Other embodiments of the basement floor drain of the present invention, and methods for its installation and use, are envisioned beyond those exemplarily described herein.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific embodiments of the invention. It is therefore to be understood that the embodiments described herein are presented by way of example only and that, within the scope of the appended claims and equivalents thereto, the invention may be practiced otherwise than as specifically described.

What is claimed is:

1-14. (canceled)

15. A method of assembling a basement floor drain, comprising:
providing a first floor drain element having an upper chamber constructed and arranged to collect water, and having an air resistant lower chamber in fluid communication with the upper chamber;
coupling the first floor drain element to a second floor drain element; and
installing the floor drain in a basement floor.

16. The method of claim 15, wherein coupling the first floor drain element to the second floor drain element comprises creating an extended upper chamber.

17. The method of claim 16, further comprising fluidly connecting the extended upper chamber to an air resistant lower chamber of the second floor drain element.

18. The method of claim 15, further comprising inserting a removable basket into a base of the upper chamber.

19. The method of claim 15, further comprising applying an end cap to a distal end of the extended upper chamber.

20. The method of claim 15, further comprising applying a removable drain cover having a plurality of apertures to the upper chamber.

21. A method of waterproofing a basement, comprising:
installing a floor drain into a floor of the basement, the floor drain having an upper chamber constructed and arranged to collect water, and having an air resistant lower chamber in fluid communication with the upper chamber; and
regulating flow of water from the upper chamber to the air resistant lower chamber.

22. The method of claim 21, further comprising fluidly connecting the air resistant lower chamber to a basement sump to facilitate extraction of collected water from the basement.

23. The method of claim 21, wherein installing the floor drain comprises adjusting a length of the upper chamber.

24. The method of claim 21, wherein installing the floor drain comprises fluidly connecting a second air resistant lower chamber to the upper chamber.

25. The method of claim 21, wherein regulating flow of water from the upper chamber to the air resistant lower chamber comprises utilizing a one-way flow valve.

26. The method of claim 25, wherein utilizing a one-way flow valve comprises utilizing a valve containing a cantilever.

27. A basement floor drain kit, comprising:
a floor drain element having an upper chamber constructed and arranged to collect water, and having an air resistant lower chamber in fluid communication with the upper chamber; and
a first upper chamber extender element constructed and arranged to increase an effective length of the upper chamber to create an extended upper chamber.

28. The kit of claim 27, further comprising a valve for regulating flow of water from the extended upper chamber to the air resistant lower chamber.

29. The kit of claim 28, wherein the valve comprises a cantilever.

30. The kit of claim 27, wherein the first upper chamber extender element is substantially identical to the floor drain element.

31. The kit of claim 27, further comprising an upper chamber end cap.

32. The kit of claim 27, further comprising a basket configured to be removably received in a base of the upper chamber.

33. The kit of claim 27, further comprising a removable drain cover defining a plurality of apertures.

34. The kit of claim 27, further comprising a second upper chamber extender element.

35. The kit of claim 34, wherein a length of the first upper chamber extender element is greater than a length of the second upper chamber extender element.
